(19) United States
(12) Patent Application Publication
(10) Pub. No.: US 2006/0223511 A1
(43) Pub. Date: Oct. 5, 2006

(54) System and method for call forwarding based on localized wireless identification

(76) Inventors: Anthony Richard Hagale, Austin, TX (US); Ryan Rozich, Austin, TX (US); Paul Stuart Williamson, Round Rock, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/098,810

(22) Filed: Apr. 5, 2005

(51) Int. Cl. H04M 3/42

(52) U.S. Cl. 455/417; 455/424

(57) ABSTRACT

A system and method for call forwarding based on localized wireless identification are provided. In one exemplary embodiment, a landline telephone is equipped with a localized landline telephone identifier device which broadcasts an identification signal within a localized limited range. A wireless telephone is equipped with a detection unit that detects the presence of the identification signal when the wireless telephone is within the localized limited range of the landline telephone. The detection of this identification signal initiates a determination as to whether call forwarding should be initiated between the two telephones. This call forwarding may be initiated automatically or in response to a user command. The user may select to either have the call forwarding performed on a one-time basis or to automatically perform call forwarding whenever the wireless telephone is within range of the landline telephone. A plurality of wireless telephones may all forward calls to the same landline telephone.

### BACKGROUND OF THE INVENTION

1. Technical Field

The present invention is generally directed to an improved communications system. More specifically, the present invention is directed to a system and method for performing call forwarding based on localized wireless identification.

2. Description of Related Art

In modern communication systems, many intelligent features and services are provided in order to provide convenience and enhanced capabilities to users of the communications systems. Such features and services include caller identification, call waiting, call blocking, call forwarding, and the like. Many of these features and services require manual setup by the user in order for these features and services to be activated, e.g., call forwarding. Other features and services are automatically activated by the communications system provider upon subscribing to the feature or service, e.g., caller identification, call waiting, etc.

Currently, in order for a user to activate the call forwarding feature/service of a communications system, the user must manually configure the telephone to perform such call forwarding. For example, a user must activate the telephone, i.e. place the telephone off-hook, dial a predefined code, e.g., *75, and then enter the telephone number of the telephone to which calls are to be forwarded. After completion of this sequence, any incoming calls to telephone number associated with the first telephone will be redirected to the telephone number entered by the user, i.e. the telephone number of the telephone to which calls are to be forwarded.

If call forwarding is to be discontinued, the user of the communications system must manually disable the call forwarding using a similar sequence of commands. The manual enabling and disabling of call forwarding must be performed each time that call forwarding is to be performed and disabled.

Recently an automated mechanism for enabling and disabling a call forwarding feature/service has been developed. Such a mechanism is described in U.S. Pat. No. 6,856,806 entitled “Method for Call Forwarding a Call from a Mobile Telephone,” issued to Bosik, et al. on Feb. 15, 2005, which is hereby incorporated by reference. With the mechanism of this system, a global positioning system or radio signal triangulation-based system is utilized to determine a current location of the mobile telephone. When the mobile telephone is at a location where the user of the mobile telephone is able to answer calls via a land-line telephone unit, the system enables a call forwarding functionality to the land-line telephone unit. While this system provides a mechanism for automatically enabling a call forwarding feature, it requires the use of a global positioning system or radio triangulation via base towers to enable such functionality. This requires expensive global positioning receivers or radio frequency based location devices. Moreover, such positioning systems have inherent errors in their determination of location which may lead to errors in the functionality of such a system.

Furthermore, the system of Bosik et al. requires improvements to the communication system service provider equipment so as to make intelligent decisions as to whether the mobile telephone is within a location of a land-line telephone and to automatically perform call forwarding when this is the case. Thus, expensive improvements to the infrastructure of the communications system are required in order to enable the mechanism described in Bosik et al.

In view of the above, it would be beneficial to have a simplified mechanism for enabling a call forwarding feature based on proximity of the mobile communications device to a land-line communications device. It would further be beneficial to have such a mechanism that does not require expensive improvements to an infrastructure of the communications system.

### SUMMARY OF THE INVENTION

The present invention provides a system and method for call forwarding based on localized wireless identification. In one exemplary embodiment, a landline telephone is equipped with a localized landline telephone identifier device which broadcasts an identification signal within a localized limited range. A wireless telephone is equipped with a detection unit that detects the presence of the identification signal when the wireless telephone is within the localized limited range of the landline telephone.

The detection of this identification signal initiates a determination as to whether call forwarding should be initiated between the two telephones. This call forwarding may be initiated automatically or in response to a user command. The user may select to either have the call forwarding performed on a one-time basis or to automatically perform call forwarding whenever the wireless telephone is within range of the landline telephone.

A plurality of wireless telephones may all forward calls to the same landline telephone. Distinctive announcements may be associated with each wireless telephone that is having its calls forwarded to the landline telephone such that when a call is forwarded to the landline telephone, the distinctive announcement is output by the landline telephone for the wireless telephone to which the call was originally directed. In this way, forwarded calls for a plurality of wireless telephones may be uniquely identified at the landline telephone.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a communications system in accordance with one exemplary embodiment of the present invention;

FIG. 2 is an exemplary diagram illustrating the interaction of the primary operational components of one exemplary embodiment of the present invention; and

FIG. 3 is a flowchart outlining an exemplary operation of the present invention.

### DETAILED DESCRIPTION OF THE PREFERRED EMBODIMENT

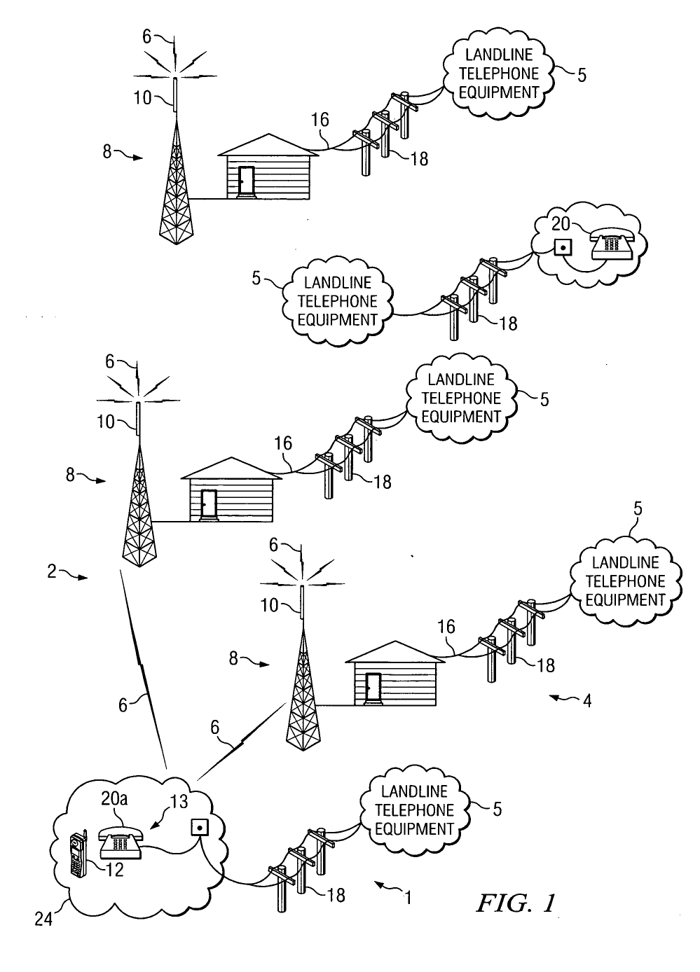

With reference now to the figures, and particularly to FIG. 1, there is shown in FIG. 1, a functional diagram of a wireless telephone system 2 and landline telephone system 4 in accordance with one exemplary embodiment of the present invention. A telephone network 1 includes both the wireless telephone system 2 and the landline telephone system 4.

The wireless telephone system 2 includes base transmitter/receiver (TX/RX) stations 8, sometimes referred to as mobile or cellular towers. The base TX/RX stations 8 have at least one antenna 10 for transmitting and receiving mobile telephone radio frequency (RF) signals 6 to and from mobile telephones 12. The base TX/RX stations 8 are typically located so that they have overlapping detection areas or cells. Further, the base TX/RX stations 8 have a connection or switch for connecting mobile telephone calls to the landline telephone system 4, or multiple base TX/RX stations 8 may share a common central switch for connecting mobile telephone calls to the landline telephone system 4. The antennas 10 may be located on a dedicated antenna tower as depicted in FIG. 1, but can also be located on a shared tower, a water storage tank, a tall building or the like, in order to provide the antenna 10 with the widest possible coverage area with the best reception of mobile telephone RF signals 6.

The landline telephone system 4 includes hardwired telephone cables 16 that may be strung between telephone poles 18 or that may be buried underground, directly or inside conduits (not shown). The telephone cables 16 may be twisted copper or aluminum pairs or multi-pair bundles, twisted and shielded copper or aluminum pairs or multi-pair bundles, multi-conductor bundles, fiber optic strands, fiber optic bundles or the like. The landline telephone system 4 also has landline telephone equipment 5 including telephone relays, switches (electrical, electronic, and/or electromechanical), digital to analog (D/A) converters, analog to digital (A/D) converters, fiber optic converters, multiplexers, microprocessors, and the like (all not shown) which connect calls to/from landline telephones 20 to/from other landline telephones 20 and which connect calls to/from mobile telephone networks 2 from/to landline telephones 20. The landline telephone system 4 is well known in the art. Therefore it is not necessary to further describe the operation of the landline telephone system 4 herein, other than indicate how it applies to the present invention.

A preferred embodiment of the present invention provides for a method of call forwarding a call, that is originally placed to a mobile telephone number of a mobile telephone 12, to a landline telephone number of a specific landline telephone 20a, wherein the call is routed through a telephone network 1 by a service provider (not shown). Using the mechanism of the exemplary embodiments of the present invention, the mobile telephone 12 is equipped with a localized landline telephone 20a detection device which may be used in conjunction with a localized landline telephone 20a identifier device associated with the landline telephone 20a.

The term “localized” is meant to refer to devices which have limited transmission/reception capabilities having relatively small ranges, e.g., 100 feet or less around the device to/from which the devices may transmit/receive signals. Examples of such localized devices include radio frequency identifier (RFID) tags and associated radio frequency receivers, Bluetooth™ transmitters/receivers, infrared transmitters/receivers, and the like. Bluetooth™ is a low cost short-range wireless specification for connecting mobile devices. Such short-range wireless transmission/reception devices are generally known in the art and thus, a detailed explanation of their operation is not provided herein. With RFID-based systems, the localized range is approximately 10-15 feet while with Bluetooth™ based systems, the range may extend to approximately 30-40 feet.

This range around the mobile telephone 12 and the landline telephone 20a is essentially a “personal communication sphere” that extends around the devices to the limits of their personal electronics' abilities. In an exemplary embodiment, this personal communication sphere, or call forwarding detection range, is specifically limited to a small range of 100 feet or less so as to ensure the close physical proximity of the mobile telephone 12, and thus the user, to the landline telephone 20a.

The present invention makes use of the localized landline telephone identifier/detection devices to determine when the wireless telephone 12 is within a localized range of the landline telephone 20a such that a user of the wireless telephone 12 may receive calls using the landline telephone 20a instead of the wireless telephone 12. The localized landline telephone identifier device transmits a signal identifying the landline telephone 20a. This signal may be continuously transmitted or selectively transmitted in response to the occurrence of a particular event. This event may be, for example, a user of the wireless telephone 12 pressing an appropriate key or series of keys on the wireless telephone 12 to select a functionality for sending a wireless telephone identifier signal to the localized landline telephone identifier device. Alternatively, the event may be the receipt of a signal from a continuously broadcasting interrogating device, such as the landline telephone detection device of the wireless telephone 12, or the like. In the case of an RFID being used to provide the landline telephone identifier signal, a received signal may actually energize the circuitry of the RFID causing the RFID tag to transmit the landline telephone identifier signal.

Encoded in the landline telephone identifier signal is identification information for identifying the landline telephone 20a. This may include, for example, a telephone number associated with the landline telephone 20a or other unique identifier for the particular landline telephone 20a. This unique identifier may be used by a call forwarding service provider of a communications system for identifying the landline telephone 20a to which calls are to be forwarded from the wireless telephone 12. This identification information is communicated to the landline telephone detection device associated with the wireless telephone 12 which determines whether to transmit an appropriate call forwarding signal to a call forwarding service provider of the wireless telephone system 2.

Upon receiving the landline telephone identifier signal, the landline telephone detection device associated with the wireless telephone 12 determines if a previous call forwarding relationship has been established for the telephone devices 12 and 20a. This determination may be made, for example, by querying a database of call forwarding relationships stored in either the wireless telephone 12 or in a call forwarding service provider of the wireless telephone system 2. Thus, for example, in one embodiment, the wireless telephone 12 may store a listing of landline telephone identifiers for which an automatic call forwarding relationship has been established. This automatic call forwarding relationship is one in which call forwarding is automatically initiated once the wireless telephone 12 receives the landline telephone identifier from the landline telephone identifier device, i.e. the wireless telephone 12 is within the localized range of the landline telephone 20a. Alternatively, such a listing may be stored by a service provider of the wireless telephone system 2 such that the wireless telephone 12 transmits a query signal to the service provider upon receiving the landline telephone identifier to determine if call forwarding is to be initiated.

If an automatic call forwarding relationship has not be pre-established for the two telephone devices 12 and 20a, then the user may be prompted to select whether call forwarding is to be initiated between the two telephone devices 12 and 20a upon receiving the landline telephone identifier and determining that a pre-established automatic call forwarding relationship has not been established. This prompt may be provided in the form of a displayed message on the wireless telephone 12 requesting that the user press one or more keys on the wireless telephone 12 keypad to select either to perform call forwarding or not. If the user selects to initiate call forwarding between the two telephone devices 12 and 20a, the wireless telephone 12 may further prompt the user to select whether such call forwarding is to be perform on a one-time basis or should be an automatic call forwarding initiated each time the two devices 12 and 20a come within range of each other. If the call forwarding is a one-time basis, the landline telephone identifier to which calls are to be forwarded is stored in a data structure representing the current call forwarding established for the wireless telephone 12. If the call forwarding is an automatic call forwarding, the landline telephone identifier to which calls are to be forwarded is stored in the data structure representing the current call forwarding and is also stored in an automatic call forwarding list of landline telephone devices to which calls are to be forwarded automatically when the wireless telephone 12 is within range of these landline telephone devices.

The current call forwarding data structure is preferably maintained in a service provider of the wireless telephone system 2 and is used when inbound calls are received for routing to the wireless telephone 12. Upon receiving a call destined for the wireless telephone 12, the current call forwarding data structure is processed to determine if calls to this wireless telephone 12 are to be forwarded to a different telephone device, e.g., landline telephone 20a. If calls are to be forwarded, the identifier stored in the current call forwarding data structure is used to re-route the calls to the appropriate telephone device, e.g., landline telephone 20a. The operations of call forwarding are generally known in the art and further explanation of these operations to perform call forwarding is not provided herein. Suffice it to say that the present invention makes use of standard call forwarding in response to an inbound call to a telephone device whose calls are to be forwarded to another telephone device. The present invention enhances such call forwarding by the use of localized wireless transmitter/receiver devices for identifying when a wireless telephone device is within range of a landline telephone device to which calls may be forwarded and then providing for either automatic or one-time call forwarding based the identification of the wireless telephone device being in range of the landline telephone device.

The landline telephone detection device may periodically determine whether the wireless telephone 12 still remains within range of the landline telephone 20a. This periodic determination may be performed in different ways depending upon the particular implementation of the present invention. For example, if the landline telephone identifier device continuously or periodically transmits its landline telephone identification signal, the landline telephone detection device may periodically determine whether such a signal has been received within a predetermined period of time. If not, then the wireless telephone 12 is determined to have moved beyond the range of the landline telephone 20a. Alternatively, the landline telephone detection device may periodically transmit an interrogation signal and determine if a response is received from the landline telephone 20a. Such an interrogation signal may be used to energize an RFID associated with the landline telephone 20a, for example, as discussed above.

If the landline telephone detection device determines that the wireless telephone 12 has moved beyond the range of the landline telephone 20a, the wireless telephone 12 may automatically transmit a call forwarding disabling signal to the service provider of the wireless telephone system 2 to thereby discontinue call forwarding to the landline telephone 20a. Alternatively, call forwarding may be manually discontinued by a user of the wireless telephone 12 by inputting an appropriate command via the keypad of the wireless telephone 12. As a result, the current call forwarding data structure maintained by the service provider is reinitialized such that no identifier of a telephone device to which calls are to be forwarded is stored in the current call forwarding data structure. Since no identifier of a call forwarded telephone device is in the current call forwarding data structure, subsequent inbound calls to the wireless telephone 12 will be routed to the wireless telephone 12.

It should be appreciated that the above description of the present invention is only exemplary and modifications to the operation of the invention may be made dependent upon the particular implementation. For example, in an alternative embodiment, for security purposes, it may be desirable to require that a user enter a password or personal identification number into the wireless telephone 12 when initiating call forwarding. In addition, the user may be required to initiate call forwarding via the landline telephone 20a by dialing an appropriate telephone number or predefined code on the buttons of the landline telephone 20a to thereby initiate call forwarding and to enter a corresponding password or personal identification number (PIN). In this way, when call forwarding is to be performed, both the password or PIN entered via the wireless telephone 12 and the landline telephone 20a are checked to determine if calls are to be forwarded to the landline telephone. Only when both passwords/PINs match will call forwarding be performed to the landline telephone 20a. Other modifications to the functions performed by the present invention may be made without departing from the spirit and scope of the present invention.

In a further embodiment of the present invention, the landline telephone 20a may receive forwarded calls from a plurality of wireless telephones 12 and may be able to announce which wireless telephone 12 from which a call is forwarded when the call is announced at the landline telephone 20a. In such an embodiment, the initiation of call forwarding is performed on both the wireless telephone 12 and the landline telephone 20a. Thus, a similar approach as discussed above is used to initiated call forwarding from the wireless telephone 12. In addition, at the landline telephone 20a, the user may dial an appropriate code or telephone number for initiating call forwarding to the landline telephone 20a. The telephone number of the wireless telephone 12 may be entered using the landline telephone 20a such that a current call forwarding data structure associated with the landline telephone 20a, stored either locally or in a service provider of the landline telephone system 4, is updated with information regarding the telephone number(s) from which calls will be forwarded. In an alternative embodiment, this registration of the telephone number from which calls are to be forwarded to the landline telephone 20a may be performed automatically in response to either automatic or manual initiation of call forwarding at the wireless telephone 12. That is, the wireless telephone 12 may send a message to the landline telephone 20a indicating the telephone number or other identifier of the wireless telephone 12.

The landline telephone 20a may associate an entry in its current call forwarding data structure with a particular announcement type. The announcement type may indicate, for example, a type of ring to use to announce calls forwarded from a particular wireless telephone 12, a message to be displayed via a display on the landline telephone 20a, a caller-ID box, or other associated display, a voice output announcement to be made, or the like. By assigning a different announcement type to each wireless telephone 12 that has its calls forwarded to the landline telephone 20a, a plurality of users may make use of the same landline telephone 20a and be able to discern which incoming calls are directed to them. This may be especially valuable in situations where a conference or other type of meeting is being conducted where there are a plurality of wireless telephone users who wish to have calls routed to a local landline telephone located in the meeting or conference place.

Thus, the present invention enhances known call forwarding systems by providing a localized mechanism for determining when a wireless telephone is within range of a landline telephone to which calls may be forwarded. The mechanisms of the present invention are less complex and less costly than the global positioning or radio signal triangulation system described in U.S. Pat. No. 6,856,806. The determination as to whether a wireless telephone is within range of the landline telephone is performed implicitly in the mechanisms of the present invention when the wireless telephone and landline telephone communicate information with one another and thus, do not require expensive improvements to the infrastructure of the telephone networks.

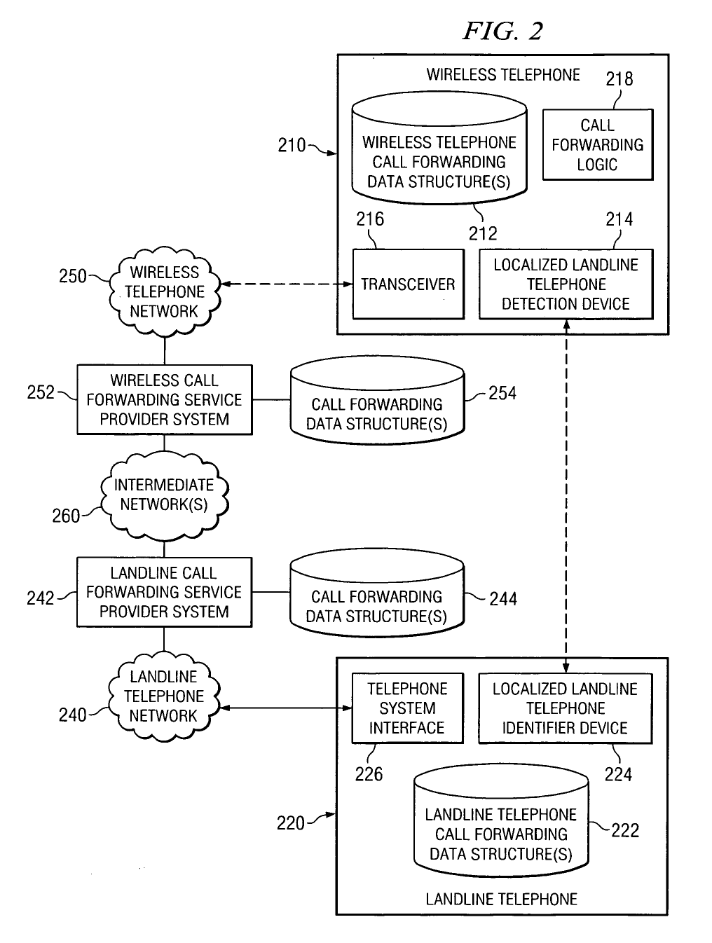

FIG. 2 is an exemplary diagram illustrating the interaction of the primary operational components of one exemplary embodiment of the present invention. As shown in FIG. 2, a wireless telephone 210 includes a transceiver 216 and localized landline telephone detection device 214. In addition to these elements, the wireless telephone 210 may further include a wireless telephone call forwarding data structure or structures 212 in which is stored data identifying the landline telephones with which automatic call forwarding initialization is to be performed.

The wireless telephone 210 communicates with a wireless telephone network 250 via wireless transceiver 216. This communication is performed wirelessly using radio frequency transmission that is generally known in the art of cellular, PCS, and other wireless telephone networks.

The localized landline telephone detection device 214 of the wireless telephone 210 communicates with a localized landline telephone identifier device 224 associated with a landline telephone 220 via a wireless communication connection when the wireless telephone 210 is within a localized range of the localized landline telephone identifier device 224. As mentioned above, this wireless communication between the localized landline telephone detection device 214 and localized landline telephone identifier device 224 is purposefully limited to technologies that have limited range, such as RFID communication, Bluetooth™, infrared, and the like. This limited range communication is used in order to ensure that call forwarding from the wireless telephone 210 to the landline telephone 220 is only initiated when the wireless telephone 210, and thus the user of the wireless telephone 210, is in close proximity to the landline telephone 220.

As shown, the landline telephone 220 may further include a landline telephone call forwarding data structure or structures 222 and a telephone system interface 226. The telephone system interface 226 provides a traditional landline telephone communication interface to the landline telephone network 240. The landline telephone call forwarding data structure or structures 222 may store various data for call forwarding including a list of one or more mobile telephone identifiers for which call forwarding is currently enabled, associated announcement types, personal identification numbers or passwords for the mobile telephone identifiers for which call forwarding is currently enabled, and the like, depending upon the particular implementation of the present invention.

Alternatively, the information stored in the wireless telephone call forwarding data structure(s) 212 and the landline telephone call forwarding data structure(s) 222 may be stored in data structures 254 and 244 associated with a wireless call forwarding service provider system 252 and a landline call forwarding service provider system 242, respectively. In such an embodiment, wireless telephone 210 and landline telephone 220 will receive call forwarding data from the data structures 254 and 244 as is necessary to perform the call forwarding described above. Such call forwarding data may be received as part of signals of an inbound call, in response to a query or request for such data from the wireless telephone 210 and landline telephone 220, or the like.

As discussed previously, in one exemplary embodiment, the localized landline telephone identifier device 224 either continuously or periodically broadcasts a landline telephone identifier signal within its localized range. When the wireless telephone 210 is within this localized range, the localized landline telephone detection device 214 receives the landline telephone identifier signal from the localized landline telephone identifier device 224. Alternatively, rather than the localized landline telephone identifier device 224 broadcasting the identifier signal continuously or periodically, the identifier signal may be broadcast in response to an interrogation signal sent from the localized landline telephone detection device 214, which may send this interrogation signal continuously, periodically, or in response to a user entered command via the wireless telephone's keypad to transmit this interrogation signal.

Receipt of the localized landline telephone identifier implicitly indicates that the wireless telephone 210 is within a distance from the landline telephone 220 where the user of the wireless telephone 210 can receive calls forwarded to the landline telephone 220. In response to receiving a localized landline telephone identifier, call forwarding logic 218 in the wireless telephone 210 or, in an alternative embodiment, in the wireless call forwarding service provider system 252, determines whether an automatic call forwarding relationship has been pre-established between the wireless telephone 210 and the landline telephone 220. The call forwarding logic 218 may be hard-coded into circuitry of the wireless telephone 210, may be provided in the form of software instructions executed on a data processing device within the wireless telephone 210, or any combination of hard-coded and software based instructions.

The determination as to whether automatic call forwarding has been pre-established may be performed by performing a lookup of the landline telephone identifier in an automatic call forwarding data structure stored in the wireless telephone call forwarding data structure(s) 212 or, in an alternative embodiment, the call forwarding data structure 254 associated with the wireless call forwarding service provider system 252. In the case of the automatic call forwarding data structure being stored in the call forwarding data structure(s) 254, the lookup is performed based on an identifier of the wireless telephone 210, to identify the call forwarding data structure(s) for the wireless telephone 210, and then based on the landline telephone identifier.

If the landline telephone identifier is present in the automatic call forwarding list data structure, then the call forwarding logic 218 automatically initiates call forwarding between the wireless telephone 210 and the landline telephone 220. This may involve, in one exemplary embodiment, the call forwarding logic 218 present in the wireless telephone sending a signal to the wireless call forwarding service provider system 252 to initiate call forwarding by the wireless call forwarding service provider system 252.

When call forwarding is initiated, the landline telephone identifier is stored in a current call forwarding data structure of the call forwarding data structures 254. As a result, when the wireless call forwarding service provider system 252 receives an incoming call for the wireless telephone 210, the call is rerouted to the landline telephone 220. This rerouting is performed, for example, by changing or adding to header information of the call signals to identify the landline telephone 220 as the recipient telephone device for the call. This rerouting causes the call to be routed through intermediate network(s) 260 and landline telephone network 240 to landline telephone 220. The intermediate network(s) 260 may include one or more additional telephone communication networks and may include portions of the wireless telephone network 250 and landline telephone network 240. The intermediate network(s) 260 provide a transition between wireless telephone network 250 and landline telephone network 240.

The call forwarding may further require interaction of the landline call forwarding service provider system 242 to perform the call forwarding. For example, for security purposes, a personal identification number or password may be required in order to establish call forwarding between the telephones 210 and 220. As a result, a check at both the wireless call forwarding service provider system 252 and at the landline call forwarding service provider system 242 may be required to ensure that the correct password/PIN was entered at both the wireless telephone 210 and the landline telephone 220.

If it is determined, by the call forwarding logic 218, that an automatic call forwarding relationship has not been established between the wireless telephone 210 and the landline telephone 220, in response to receipt of the landline telephone identifier signal, the call forwarding logic 218 may provide a user of the wireless telephone 210 with a prompt for the user to select whether to initiate call forwarding or not. If the user selects to initiate call forwarding, an option may be provided to the user to set up this call forwarding as a one-time call forwarding relationship or an automatic call forwarding relationship which is to be established automatically each time the wireless telephone 210 is within the localized range of the landline telephone 220.

If the user selects to establish an automatic call forwarding relationship, the landline telephone identifier is stored in an automatic call forwarding data structure associated with the wireless telephone 210. This automatic call forwarding data structure may be stored either in wireless telephone call forwarding data structure(s) 212 of the wireless telephone 210 or in the call forwarding data structure(s) 252 associated with the wireless call forwarding service provider system 252.

Whether the user selects a one-time call forwarding relationship or an automatic call forwarding relationship, the landline telephone identifier is stored in a current call forwarding data structure in the call forwarding data structures 254 associated with the wireless call forwarding service provider system 252. As discussed above, this current call forwarding data structure is then used to perform call forwarding for inbound calls directed to the wireless telephone 210.

Periodically, the call forwarding logic 218 of the wireless telephone 210 may determine whether a landline telephone identifier signal from the landline telephone 220 has been received within a predetermined period of time. If it is determined that a landline telephone identifier signal has been received within the predetermined period of time, then it is determined that the wireless telephone 210 is still within the localized range of the landline telephone 220. If it is determined that the landline telephone identifier signal has not been received within the predetermined period of time, the it is determined that the wireless telephone 210 has traveled beyond the localized range of the landline telephone 220 and thus, the user cannot continue to receive forwarded calls at the landline telephone 220. As a result, the current call forwarding is discontinued and the current call forwarding data structure(s) are reinitialized. This discontinuing of call forwarding may further be performed in response to a user entered command, via the keypad of the wireless telephone or the keypad for example, to discontinue the call forwarding.

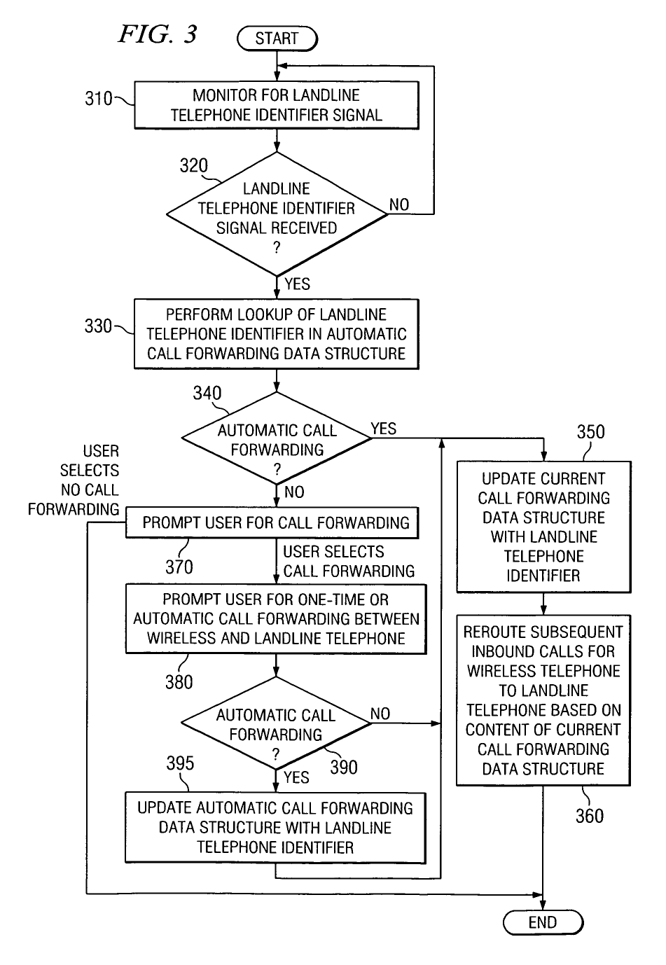

FIG. 3 is a flowchart outlining an exemplary operation of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

The operation shown in FIG. 3 is an operation for initiating a call forwarding relationship between a wireless telephone and a landline telephone. It is assumed in this operation that a landline telephone identifier signal is only received when the wireless telephone is within the localized range of the landline telephone. Thus, the landline telephone identifier signal is only received when the wireless telephone is in close proximity to the landline telephone such that the user may receive forwarded calls via the landline telephone.

As shown in FIG. 3, the operation starts by monitoring for a landline telephone identifier signal (step 310). A determination is made as to whether a landline telephone identifier signal has been received (step 320). If not, the operation returns to step 310. If a landline telephone identifier signal has been received, the landline telephone identifier signal is used as a basis for performing a lookup in an automatic call forwarding data structure (step 330). A determination is made as to whether an automatic call forwarding relationship has been pre-established for the mobile telephone and the landline telephone based on the landline telephone identifier (step 340). If so, then a current call forwarding data structure is updated to include the landline telephone identifier (step 350) and subsequent inbound calls to the wireless telephone are forwarded to the landline telephone based on the content of the current call forwarding data structure (step 360).

If an automatic call forwarding relationship has not been established between this wireless telephone and the landline telephone, a user of the wireless telephone may be provided with a prompt to select whether to perform call forwarding to the landline telephone or not (step 370). If the user selects to not perform call forwarding, the operation terminates. If the user selects to perform call forwarding, a further option may be provided to the user to select whether the call forwarding is to be a one-time call forwarding or an automatic call forwarding relationship (step 380). If the call forwarding is to be an automatic call forwarding relationship (step 390), an automatic call forwarding data structure associated with the wireless telephone is updated to include the landline telephone identifier (step 395). Thereafter, or if the user selects a one-time call forwarding, the operation continues to step 350. Although not shown in the flowchart, as described previously, the call forwarding may be discontinued once initiated using the methodology outlined in the flowchart, either manually by the user or automatically once the mobile telephone moves beyond the localized range of the landline telephone.

Thus, the present invention provides a simplified mechanism for determining when a user of a mobile telephone is in proximity to a landline telephone to which calls may be forwarded. The present invention does not require extensive improvements to the communication networks to provide mechanisms for determining whether the wireless telephone is near the landline telephone. The present invention may make use of inexpensive RFID transmitter/detectors, Bluetooth™ transceivers, or the like, to implicitly determine when the wireless telephone is within a localized range of a landline telephone and thereby initiate call forwarding from the wireless telephone to the landline telephone.

It should be appreciated that the embodiments described above are only exemplary. Modifications to these embodiments may be made without departing from the spirit and scope of the present invention. For example, rather than have the detector associated with the wireless telephone and the identifier device associated with the landline telephone, these devices may be swapped such that the identifier device is associated with the wireless telephone and the detector device is associated with the landline telephone.

Moreover, the present invention is not limited to call forwarding between a mobile telephone and a landline telephone. To the contrary, call forwarding may be performed between two mobile telephones, for example, if desired. In addition, rather than forwarding calls directed to the mobile telephone, to the landline telephone, the present invention may equally be used to forward calls directed to the landline telephone, to the mobile telephone. So long at the two communication devices communicate with each other to wirelessly broadcast, within a localized limited range, and recognize an identifier signal from one communication device in order to initiate call forwarding, such embodiments are intended to be within the spirit and scope of the present invention.

Furthermore, the mechanisms of the present invention may be used to forward other types of communications between a first communication device and a second communication device. For example, alphanumeric messages may be forwarded from wireless telephones, pagers, PDAs, or the like to another device, such as a personal computer, webTV device, or the like, based upon a detected proximity of the first device to the second device. As long as a localized identifier and detection mechanism, e.g., RFID, Bluetooth™, infrared or the like, is used to initiate this forwarding of communications from the first device to the second device, such embodiments are intended to be within the spirit and scope of the present invention.

As a further embodiment of the present invention, rather than being integrated with the landline telephone or landline communication device, the landline telephone identifier device may be a separate unit that is coupled to, or otherwise associated with, the landline telephone/communication device. For example, an external unit may be provided that is coupled to the landline telephone via the telephone network interface and a standard telephone wire. With such an embodiment, the unit may stand between the landline telephone and the telephone network in a communication link between the landline telephone and the telephone network. Other modifications to the exemplary embodiments described above may be made without departing from the spirit and scope of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for forwarding communications from a first communication device to a second communication device, comprising:
receiving, in the first communication device, an identifier signal of the second communication device, wherein the identifier signal is a wireless broadcast by the second communication device to a localized limited range around the second communication device;
determining whether to initiate forwarding of communications, directed to one of the first communication device or the second communication device, to the other of the first communication device and the second communication device, based on an identifier of the second communication device received in the identifier signal; and
in response to determining to initiate forwarding of communications to one of the first communication device or the second communication device based on the identifier of the second communication device, initiating call forwarding of communications to one of the first communication device or the second communication device.

2. The method of claim 1, wherein the identifier signal is wirelessly broadcast by the second communication device using one of a Bluetooth communication link, a radio frequency identification (RFID) tag, or an infrared communication link.

3. The method of claim 1, wherein the first communication device is a wireless telephone, and wherein the second communication device is a landline telephone.

4. The method of claim 3, wherein communications are forwarded from the wireless telephone to the landline telephone.

5. The method of claim 1, wherein at least one of the first communication device or the second communication device is a wireless communication device.

6. The method of claim 1, wherein the communications are one of telephone calls or alphanumeric messages.

7. The method of claim 1, wherein determining whether to initiate forwarding of communications to one of the first communication device or the second communication device includes:
performing a lookup of the identifier of the second communication device in an automatic forwarding data structure, wherein initiating call forwarding of communications to one of the first communication device or the second communication device is automatically performed if the identifier of the second communication device is present in the automatic forwarding data structure.

8. The method of claim 7, wherein the first communication device is a wireless communication device, and wherein determining whether to initiate forwarding of communications to one of the first communication device or the second communication device further includes:
providing a prompt to a user of the wireless communication device to select whether or not to initiate forwarding of communications to the second communication device, if the identifier of the second communication device is not present in the automatic forwarding data structure.

9. The method of claim 8, wherein determining whether to initiate forwarding of communications to one of the first communication device or the second communication device further includes:
providing an option to the user of the wireless communication device to select either a one-time forwarding of communications to the second communication device or an automatic forwarding of communications to the second communication device, wherein the automatic forwarding of communications results in forwarding of communications to be automatically initiated each time the wireless communication device is within a localized range of the second communication device.

10. The method of claim 1, wherein the localized limited range is approximately 100 feet or less around the second communication device.

11. A system for forwarding communications from a first communication device to a second communication device, comprising:
a receiver associated with an the first communication device; and
call forwarding logic coupled to the first communication device, wherein:
the receiver receives an identifier signal of the second communication device, that is wirelessly broadcast by the second communication device to a localized limited range around the second communication device,
the call forwarding logic determines whether to initiate forwarding of communications, directed to one of the first communication device or the second communication device, to the other of the first communication device and the second communication device, based on an identifier of the second communication device received in the identifier signal, and
in response to determining to initiate forwarding of communications to one of the first communication device or the second communication device based on the identifier of the second communication device, the call forwarding logic initiates call forwarding of communications to one of the first communication device or the second communication device.

12. The system of claim 11, wherein the identifier signal is wirelessly broadcast by the second communication device using one of a Bluetooth communication link, a radio frequency identification (RFID) tag, or an infrared communication link.

13. The system of claim 11, wherein the first communication device is a wireless telephone, and wherein the second communication device is a landline telephone.

14. The system of claim 13, wherein communications are forwarded from the wireless telephone to the landline telephone.

15. The system of claim 11, wherein at least one of the first communication device or the second communication device is a wireless communication device.

16. The system of claim 11, wherein the communications are one of telephone calls or alphanumeric messages.

17. The system of claim 11, wherein the call forwarding logic determines whether to initiate forwarding of communications to one of the first communication device or the second communication device by:
performing a lookup of the identifier of the second communication device in an automatic forwarding data structure, wherein initiating call forwarding of communications to one of the first communication device or the second communication device is automatically performed if the identifier of the second communication device is present in the automatic forwarding data structure.

18. The system of claim 17, wherein the first communication device is a wireless communication device, and wherein the call forwarding logic determines whether to initiate forwarding of communications to one of the first communication device or the second communication device further by:
providing a prompt to a user of the wireless communication device to select whether or not to initiate forwarding of communications to the second communication device, if the identifier of the second communication device is not present in the automatic forwarding data structure.

19. The system of claim 18, wherein the call forwarding logic determines whether to initiate forwarding of communications to one of the first communication device or the second communication device further by:
providing an option to the user of the wireless communication device to select either a one-time forwarding of communications to the second communication device or an automatic forwarding of communications to the second communication device, wherein the automatic forwarding of communications results in forwarding of communications to be automatically initiated each time the wireless communication device is within a localized range of the second communication device.

20. The system of claim 11, wherein the localized limited range is approximately 100 feet or less around the second communication device.
